(19) United States
(12) Patent Application Publication
(10) Pub. No.: US 2012/0314977 A1
(43) Pub. Date: Dec. 13, 2012

(54) HEAT BONDING METHOD AND HEAT BONDING DEVICE

(76) Inventor: Tetsuya MATSUO, Osaka (JP)

(21) Appl. No.: 13/493,504

(22) Filed: Jun. 11, 2012

(30) Foreign Application Priority Data
Jun. 10, 2011 (JP) 2011-129796

(51) Int. Cl. B65D 33/25; B32B 37/14; B32B 37/08; B32B 3/06

(52) U.S. Cl. 383/97; 428/99; 156/308.2; 156/498

(57) ABSTRACT

A method for heat-bonding together a film and a zipper tape using a heat bonding device including a guide unit which has at a first flat surface a linearly extending first groove for guiding an engaging elements of a zipper tape, the groove being slightly wider than a width of the engaging elements and slightly shallower than a height of the zipper tape, and which has cooling means for keeping a vicinity of the first groove cold, and a first heating unit that is disposed facing the first flat surface of the guide unit, has a third flat surface that is so shaped as to cover the first groove, and has a mechanism such that the third flat surface approaches and is separated from the position of the first flat surface.

### TECHNICAL FIELD

The present invention relates to a method and device for producing a bag with a zipper, and more particularly to a method for attaching a zipper tape to a film configuring a bag main body and a producing device.

### TECHNICAL FIELD

In a conventional method for producing a bag with a zipper, a synthetic resin part of zipper tapes is fused and bonded by heat to the surface of a synthetic resin film that becomes a bag main body, thereby producing a bag main body film, the zipper tapes each having a male or female engaging element on one side of a tape-shaped base film made of synthetic resin.

For example, Patent Document 1 discloses a method for heat-bonding zipper tapes to films for a bag main body. This method is described with reference to FIGS. 10 and 11. This method first sandwiches a seal receiver 5 between flange parts 4 forming part of tape-shaped bases of zipper tapes 1, 2 that are engaged with each other beforehand. Further, main body films 3 are superimposed thereon to sandwich the zipper tapes 1, 2 therebetween. In this state, heating units 6 are placed on the outside of the main body films 3 respectively, to pressurize and sandwich the main body films 3 and the flange parts 4 of the zipper tapes between flat surfaces of the heating units 6 and the seal receiver 5. By allowing the flat surfaces of the heating units 6 to pressurize and come in contact with the seal receiver 5 when the main body films 3 and the zipper tapes 1, 2 are stopped, the main body films 3 and the zipper tapes 1, 2 are sandwiched between the flat surfaces of the heating units 6 and heat-bonded to each other. When the flat surfaces of the heating units 6 and the seal receiver 5 are separated from each other, the main body films 3 and the zipper tapes 1, 2 are sent sequentially by a certain length.

Patent Document 2 and Patent Document 3 each disclose a method for producing a bag with a clamping device by using main body films. In this method, as shown in FIG. 12, the zipper tapes 3, 4 are superimposed on main body films 5, 6 in a manner as to allow the passage of the zipper parts of the zipper tapes 3, 4 in a zipper introducing groove 33 formed along a circumferential direction of a rotating drum 32. In this state, the zipper tapes 3, 4 and the main body films 5, 6 are caused to continuously travel by rotating the drum 32, and the zipper tapes 3, 4 are fused continuously to the main body films 5, 6 by a seal bar 35 on a circumferential surface of the rotating drum 34, the seal bar 35 having a fusing surface that is so curved as to follow the shape of the circumferential surface of the rotating drum 34. Subsequently, the zipper tapes 3, 4 having a pair of zipper parts engaged with each other are fused.

However, when the flanges of the zipper tapes, including the tip parts thereof, are heat-bonded to the main body films by using the methods disclosed in Patent Documents 1 to 3, the main body films are fused to the seal receiver described in Patent Document 1 and to the drum described in Patent Document 2 or 3, causing wrinkles on the main body films. Leaving the tip parts of the flanges un-bonded in order to avoid the generation of wrinkles, degrades the appearance of the produced bags. Furthermore, contents in the bag might be wedged between the unbonded parts.

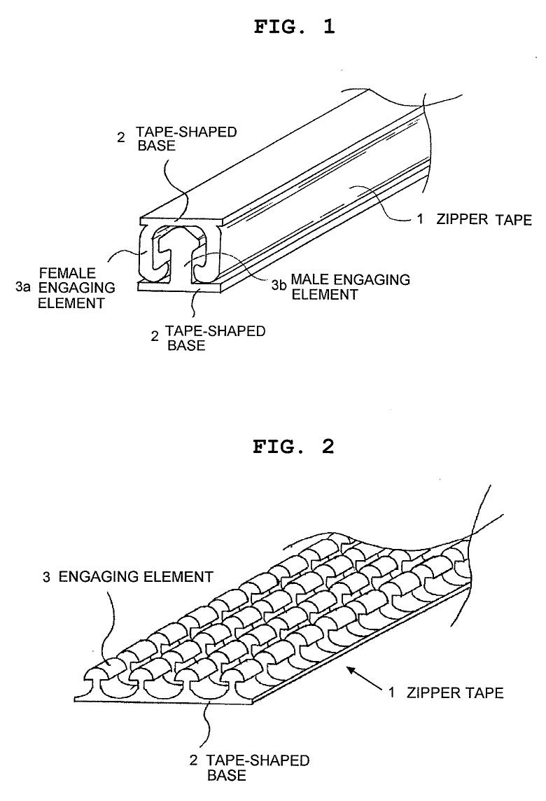

For the purpose of reducing the materials or for aesthetic reasons, each of the zipper tapes can be the one that has the width of the tape-shaped base reduced as much as possible or the one in which the width of engaging elements is substantially the same as the width of the tape-shaped base, as shown in FIGS. 1 and 2. Because such zipper tapes have no flanges, the zipper tapes cannot be effectively heat-bonded to the film without generating wrinkles.

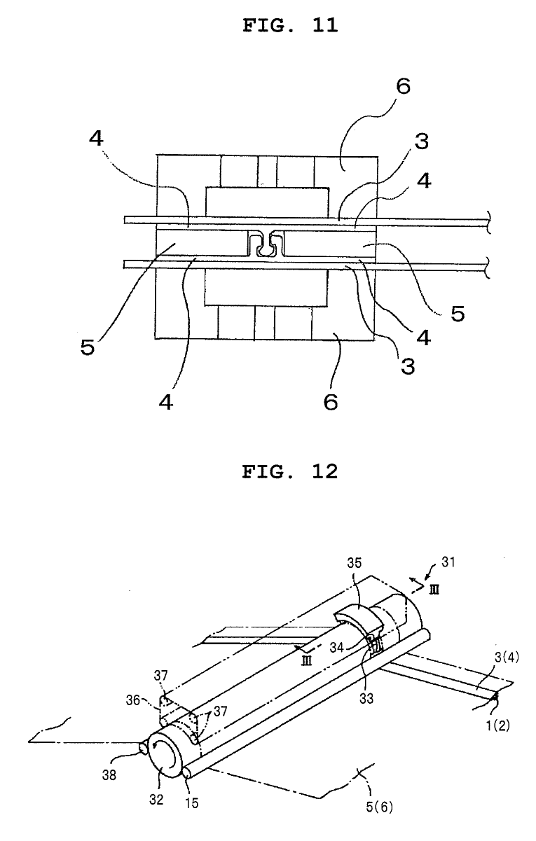

Especially when producing a film with zipper tapes in order to create a packaging bag shown in FIGS. 14(b) and 15(b) of Patent Document 4, approximately half of one side in the width direction of the tape-shaped base needs to be heat-bonded to the film in order to provide a difference between the strength required for opening from the outside and the strength required for opening from the inside of the bag. Unfortunately, the methods described in Patent Documents 1 to 3 cannot be applied to this kind of circumstance.

In addition, as is disclosed in Patent Document 1, the bag production step is normally an intermittent operation for sequentially sending films, wherein the films are heat-bonded to each other by the heating units when the films are stopped. The method described in Patent Document 2 or 3, on the other hand, heat-bonds the film and the zipper tapes to each other by the continuous operation of the rotating drum, which cannot easily be linked to the bag production step that carries out the intermittent operation.

### PRIOR ART DOCUMENTS

### Patent Documents

[Patent Document 1] Japanese Utility Model Publication No. 3-36825

[Patent Document 2] WO 2006/075644

[Patent Document 3] Japanese Patent Publication No. 9-39121

[Patent Document 4] Japanese Patent Publication No. 2006-213366

### SUMMARY OF THE INVENTION

### Problem to be Solved

The present invention was made in order to eliminate the problems described above, and an object thereof is to provide an device and method capable of heat-bonding together a zipper tape and a main body film without generating wrinkles on the film, even when heat-bonding the entire zipper tape including a tip end part of its flange to the film or even when the zipper tape does not have a flange.

### Solution to Problem

As a result of the keen examination by the inventors of the present invention in order to solve the above problems, the inventors have accomplished the present invention capable of achieving the object described above, by heat-bonding together a zipper tape and a film by using a heat bonding device, the heat bonding device including: a guide unit which has at a surface thereof a linearly extending groove for guiding engaging elements of the zipper tape, the groove being slightly wider than a width of the engaging elements and slightly shallower than a height of the zipper tape, and which has cooling means for keeping the vicinity of the groove cold; and a heating unit that is disposed facing the guide unit, has a heating surface that is so shaped as to substantially cover a predetermined part of the groove, and has a mechanism such that the heating surface approaches and is separated from the surface of the guide unit provided with the groove.

The configurations of the present invention for accomplishing the object described above are as follows.

(1) A method for heat-bonding together a film and a zipper tape having one or more engaging elements on one surface side of a tape-shaped base, the heat bonding method comprising the steps of: using a heat bonding device including a guide unit which has at one surface thereof (a first flat surface) a linearly extending groove (a first groove) for guiding the engaging elements of the zipper tape, the groove being slightly wider than a width of the engaging elements and slightly shallower than a height of the zipper tape, and which has cooling means for keeping a vicinity of the first groove cold, and a first heating unit that is disposed facing the first flat surface of the guide unit, has a surface (a third flat surface) that is so shaped as to substantially cover a predetermined part of the first groove, and has a mechanism such that the third flat surface approaches and is separated from the position of the first flat surface, transferring the zipper tape when the third flat surface of the first heating unit is separated from the position of the first flat surface of the guide unit, to allow the passage of the engaging elements in the first groove so that the zipper tape is disposed such that the tape-shaped base is directed in a direction in which the first groove is opened; disposing the film so as to cover the zipper tape; and heat-bonding together the zipper tape and the film by bringing the third flat surface of the first heating unit close to the position of the first flat surface to subject the film to contact-heating for a predetermined period of time, the first heating unit being kept at a predetermined temperature.

(2) A method for heat-bonding together films and zipper tapes each having one or more engaging elements on one surface side of a tape-shaped base, the heat bonding method comprising the steps of: using a heat bonding device including a guide unit which has at a surface (a first flat surface) on one side thereof a linearly extending groove (a first groove) for guiding the engaging elements of one of the zipper tapes, the groove being slightly wider than a width of the engaging elements and slightly shallower than a height of the zipper tape, which has, at a position corresponding to the first groove and at a surface (a second flat surface) on the other side thereof parallel to the first flat surface, a linearly extending groove (a second groove) for guiding the engaging elements of the other zipper tape, the groove being slightly wider than the width of the engaging elements, slightly shallower than the height of the zipper tape and parallel to the first groove, and which has cooling means for keeping vicinities of the first and second grooves cold, a first heating unit that is disposed facing the first flat surface of the guide unit, has a surface (a third flat surface) that is so shaped as to substantially cover a predetermined part of the first groove, and has a mechanism such that the third flat surface approaches and is separated from the position of the first flat surface, and a second heating unit that is disposed facing the second flat surface of the guide unit, has a surface (a fourth flat surface) that is so shaped as to substantially cover a predetermined part of the second groove, and has a mechanism such that the fourth flat surface approaches and is separated from the position of the second flat surface, transferring the zipper tapes when the third flat surface of the first heating unit is separated from the position of the first flat surface of the guide unit and the fourth flat surface of the second heating unit is separated from the position of the second flat surface of the guide unit, to allow the passage of the engaging elements in the first and second grooves so that the zipper tapes are respectively disposed such that the tape-shaped bases are directed in a direction in which the first and second grooves are opened; disposing the films so as to cover the zipper tapes; and heat-bonding together the zipper tapes and the films by bringing the third flat surface of the first heating unit close to the position of the first flat surface of the guide unit and bringing the fourth flat surface of the second heating unit close to the position of the second flat surface of the guide unit, to subject the films to contact-heating for a predetermined period of time, the first heating unit being kept at a predetermined temperature.

(3) The heat bonding method according to (1) or (2), wherein, in the zipper tape or tapes, the engaging elements are provided as a continuous row in a longitudinal direction of the zipper tape or tapes.

(4) The heat bonding method according to (1) or (2), wherein, in the zipper tape or tapes, the engaging elements are provided discontinuously in a longitudinal direction of the zipper tape or tapes, and a plurality of rows of the discontinuous engaging elements are provided in a width direction of the zipper tape or tapes.

(5) The heat bonding method according to (2), wherein the zipper tapes are configured such that the engaging elements of one of the zipper tapes are provided discontinuously in a longitudinal direction of the tape and a plurality of rows of the discontinuous engaging elements are provided in a width direction, while the engaging elements of the other zipper tape are provided as a continuous row in a longitudinal direction of the tape.

(6) A heat bonding device for heat-bonding together a film and a zipper tape having one or more engaging elements on one surface side of a tape-shaped base, the heat bonding device comprising: a guide unit which has at one surface thereof (a first flat surface) a linearly extending groove (a first groove) for guiding the engaging elements of the zipper tape, the groove being slightly wider than a width of the engaging elements and slightly shallower than a height of the zipper tape, and which has cooling means for keeping a vicinity of the first groove cold; and a first heating unit that is disposed facing the first flat surface of the guide unit, has a surface (a third flat surface) that is so shaped as to substantially cover a predetermined part of the first groove, and has a mechanism such that the third flat surface approaches and is separated from the position of the first flat surface.

(7) A heat bonding device for heat-bonding together films and zipper tapes each having one or more engaging elements on one surface side of a tape-shaped base, the heat bonding device comprising: a guide unit which has at one of surfaces thereof (a first flat surface) a linearly extending groove (a first groove) for guiding the engaging elements of one of the zipper tapes, the groove being slightly wider than a width of the engaging elements and slightly shallower than a height of the zipper tape, which has, at a predetermined position of a surface (a second flat surface) on the other side thereof parallel to the first flat surface, a linearly extending groove (a second groove) for guiding the engaging element of the other zipper tape, the groove being slightly wider than the width of the engaging elements, slightly shallower than the height of the other zipper tape and parallel to the first groove, and which has cooling means for keeping vicinities of the first and second grooves cold; a heating unit that is disposed facing the first flat surface of the guide unit, has a surface (a third flat surface) that is so shaped as to substantially cover a predetermined part of the first groove, and has a mechanism such that the third flat surface approaches and is separated from the position of the first flat surface; and another heating unit that is disposed facing the second flat surface of the guide unit, has a surface (a fourth flat surface) that is so shaped as to substantially cover a predetermined part of the second groove, and has a mechanism such that the fourth flat surface approaches and is separated from the position of the second flat surface.

(8) The heat bonding device according to (6) or (7), wherein the cooling means is provided in the vicinity of the first groove of the guide unit and is a flow path capable of allowing the passage of a cooling medium therethrough.

(9) A film with a zipper tape, which is produced by the heat bonding method described in any of (1) to (5).

(10) A packaging bag, which is produced using the film with a zipper tape described in (9).

(11) A packaged body, which is obtained by filling up the packaging bag of (10) with contents.

Aspects of the aforementioned inventions (1) to (11) are described hereinafter as Aspects (1) to (11).

### Advantageous Effects of the Invention

According to Aspect (1), because the engaging elements of the zipper tape are positioned within the first groove, the zipper tape can be kept straight without being twisted.

Consequently, the zipper tape can be heat-bonded in a linear fashion in a direction in which the first groove extends. Because the guide unit is provided with the cooling means for cooling the vicinity of the first groove, the inside of the first groove can be kept cold. Therefore, even when the zipper tape and the film are heat-bonded to each other by the heating unit, the temperature of the engaging element part is prevented from increasing, preventing the engaging element part from being softened by heat. Furthermore, because the guide unit is provided with the cooling means for cooling the vicinity of the first groove, heat-bonding together the zipper tape and the film by means of the heating unit allows the surface of the film contacting with the guide unit to immediately release the heat to the guide part, thereby preventing the temperature of the film from increasing above the predetermined temperature. Thus, the surface of the film that is in contact with the guide unit is not melted by heat and therefore does not stick to the guide unit. Because the film is prevented from sticking to the guide unit in this manner, no wrinkles are generated on the film even when the film and the zipper tapes are sent sequentially. In addition, the method for heat-bonding together the zipper tape and the film while sequentially sending the film and the zipper tape can be easily passed on to the step of sequentially sending films and producing a bag.

According to Aspect (2), in addition to the effects of Aspect (1), the guide unit is provided with a second groove extending parallel to the first groove. Therefore, the engaging elements of the zipper tapes can be positioned within the first and second grooves. As a result, the zipper tapes can be kept straight without being twisted when conveyed. Moreover, the engaging elements can be kept parallel and close to each other. Thus, when continuously forming films into bags, the engaging elements can be engaged with each other easily without requiring alignment of the positions thereof.

According to Aspect (3), in addition to the effects of Aspect (1) or (2), the zipper tape and the film can be heat-bonded to each other easily, when the engaging elements of the zipper tape have a continuous structure in the longitudinal direction of the zipper tape.

According to Aspect (4), in addition to the effects of Aspect (1) or (2), the zipper tape and the film can be heat-bonded to each other easily, when the engaging elements of the zipper tape are provided discontinuously in the longitudinal direction of the zipper tape and the discontinuous engaging elements are provided in a plurality of rows in the width direction of the zipper tape.

According to Aspect (5), in addition to the effects of Aspect (2), the zipper tape and the film can be heat-bonded to each other easily, when the zipper tape is configured such that the engaging elements of one zipper tape are provided discontinuously in a longitudinal direction of the tape and a plurality of rows of the discontinuous engaging elements are provided in a width direction, while the engaging elements of the other zipper tape are provided as a continuous row in a longitudinal direction of the tape.

The zipper tape and the film can be heat-bonded to each other easily by implementing the production method of Aspect (1) using the device of Aspect (6).

The zipper tape and the film can be heat-bonded to each other easily by implementing the production method of Aspect (2) using the device of Aspect (7).

The zipper tape and the film can be heat-bonded to each other easily by implementing the production method of Aspect (1) or (2) using the device of Aspect (8).

The film with a zipper tape according to Aspect (9) is favorable as a material for producing a packaging bag because the zipper tape and the film are heat-bonded to each other at low costs and have excellent qualities.

The packaging bag according to Aspect (10) can be used favorably as packaging bags made of various materials, due to the excellent functionality and appearance thereof.

Because the packaged body according to Aspect (11) uses a packaging bag of excellent functionality and appearance, this packaged body can have the excellent functionality and appearance as a packaging product.

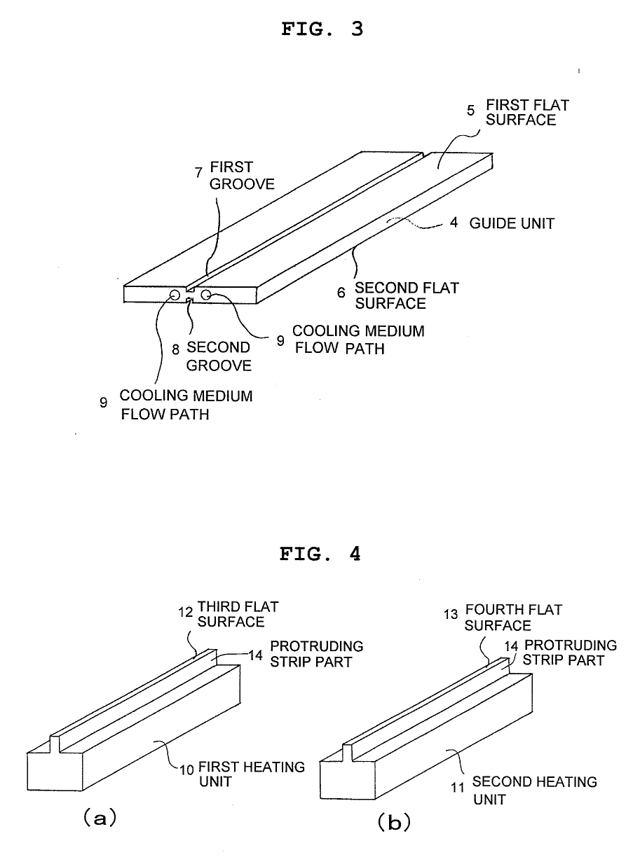

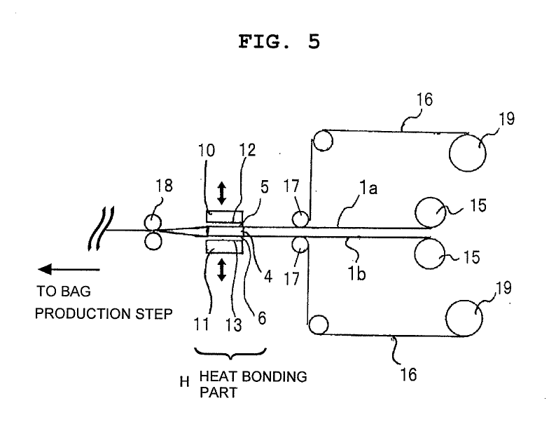

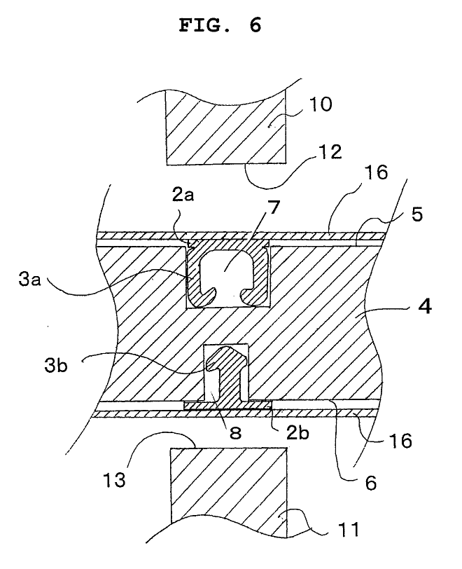

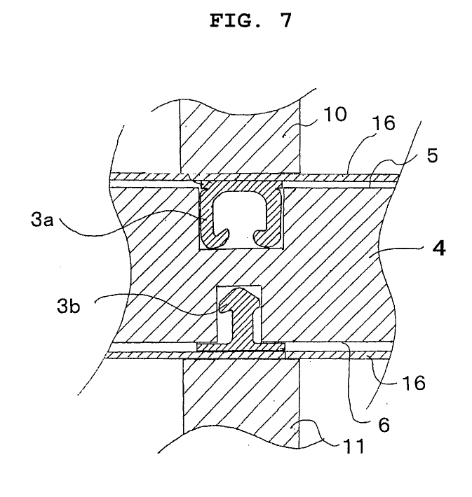

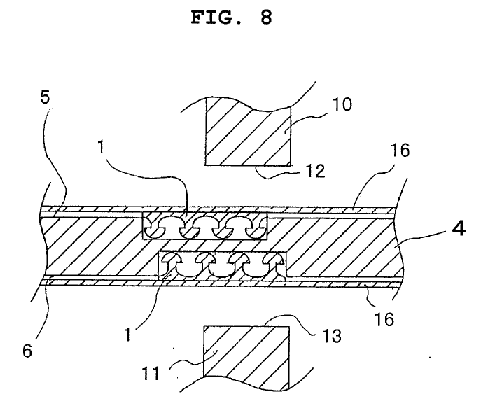

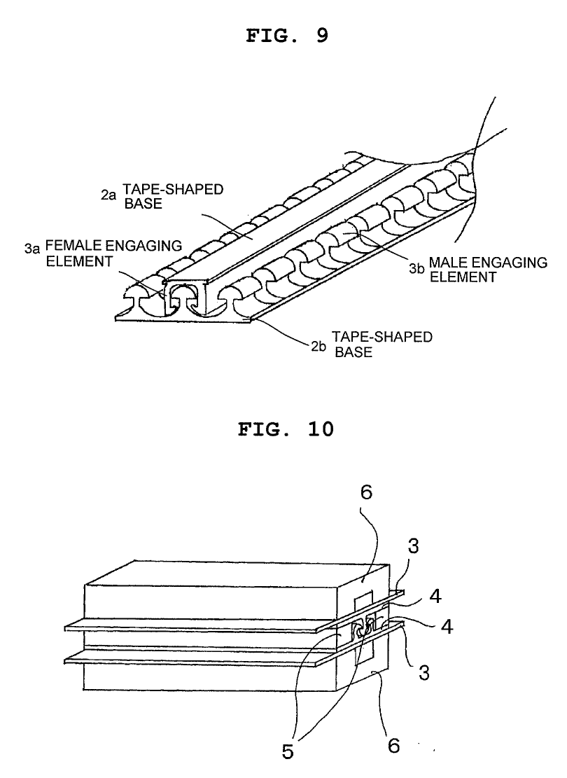

### BRIEF DESCRIPTION OF DRAWINGS

[FIG. 1] FIG. 1 is a diagram showing an example of a zipper tape having an engaging element.

[FIG. 2] FIG. 2 is a diagram showing another example of the zipper tape having engaging elements.

[FIG. 3] FIG. 3 is a diagram showing an example of a guide unit of a heat bonding device according to the present invention.

[FIG. 4] FIG. 4 is a diagram showing examples of heating units of the heat bonding device according to the present invention.

[FIG. 5] FIG. 5 is a diagram showing an entire schematic configuration of a heat bonding method according to the present invention.

[FIG. 6] FIG. 6 is a diagram showing how the zipper tape shown in FIG. 1 is used in the heat bonding device according to the present invention.

[FIG. 7] FIG. 7 is a diagram showing how the zipper tape shown in FIG. 1 is used in the heat bonding device according to the present invention.

[FIG. 8] FIG. 8 is a diagram showing how the zipper tape shown in FIG. 2 is used in the heat bonding device according to the present invention.

[FIG. 9] FIG. 9 is a diagram showing an example of zipper tapes having engaging elements.

[FIG. 10] FIG. 10 is a diagram showing how films are heat-bonded to zipper tapes using a conventional heat bonding device.

[FIG. 11] FIG. 11 is a cross-sectional diagram of the heat bonding device shown in FIG. 10.

[FIG. 12] FIG. 12 is a diagram showing another example of the conventional heat bonding device.

### MODE FOR CARRYING OUT INVENTION

The present invention is described hereinafter in detail.

FIG. 1 is a diagram showing an example of a zipper tape to which a heat bonding method of the present invention can be applied, wherein a male engaging element and a female engaging element are fitted into each other.

This zipper tape 1 is configured by a female zipper tape la in which a female engaging element 3 of a continuous structure is formed in a longitudinal direction on a surface on one side of a tape-shaped base 2 and a male zipper tape 1b in which a male engaging element 4 of a continuous structure is formed in the longitudinal direction on a surface on one side of another tape-shaped base 2. The width of the tape-shaped base 2 is set to be equivalent to the width of the female engaging element 3.

FIG. 2 shows another example of the zipper tape to which the heat bonding method of the present invention can be applied.

In this zipper tape, a plurality of unit engaging elements are provided discontinuously in the longitudinal direction of the tape-shaped base, to form a plurality of parallel rows. This zipper tape can be engaged with another zipper tape by engaging a line of engaging elements between opposing engaging elements, as viewed cross-sectionally in a width direction of the zipper tape. In other words, rows of engaging elements of one zipper tape are shifted in the width direction so as to be positioned between rows of engaging elements of another zipper tape, and these engaging elements of the both zipper tapes are pressed against each other to push the engaging elements of the former zipper tape into the engaging elements of the latter zipper tape.

The heat bonding method of the present invention uses a heat bonding device having a guide unit shown in FIG. 3 and heating units shown in FIG. 4 in order to heat-bond a zipper tape and a film together.

The guide unit has a groove at one surface thereof (referred to as “first flat surface”) in order to guide the engaging elements of the zipper tape. If need be, the guide unit may have a groove at the other surface thereof in order to guide the engaging element of the zipper tape. FIG. 3 shows a guide unit that has grooves at both surfaces thereof.

One of the grooves is a linear groove (referred to as “first groove”) that is slightly wider than the width of engaging element and slightly shallower than the height of the zipper tape.

The guide unit has cooling means for keeping the vicinity of the first groove cold. In the example shown in FIG. 3, the inside of the guide unit is pierced with a flow path that is parallel to the first groove, the flow path functioning as the cooling means. A cooling medium such as water is let flow through this flow path.

The heating unit (referred to as “first heating unit”) is disposed facing the first flat surface of the guide unit, and a surface (referred to as “third flat surface”) facing the guide unit is so shaped as to substantially cover a predetermined part of the first groove. The first heating unit is provided with a mechanism such that the second flat surface is designed so as to approach and separate from the position of the first flat surface of the guide unit. While the third flat surface of the first heating unit is away from the position of the first flat surface of the guide unit, the zipper tape is transferred in order to allow the passage of the engaging elements thereof in the first groove of the guide unit and is then disposed such that the tape-shaped base is directed in a direction in which the first groove is opened. After disposing the film so as to cover the zipper tape, the third flat surface of the first heating unit that is kept at a predetermined temperature is brought close to the position of the first flat surface of the guide unit, to subject the film to contact-heating for a predetermined period of time. In this manner, the zipper tape and the film are heat-bonded to each other.

Incidentally, a film of a bag main body is normally configured by laminating films that have different melting temperatures for the outer surface and the inner surface of the bag. In so doing, a film that melts at a lower temperature is used for the inner surface of the bag as compared with the outer surface of the bag to form the inner surface as a heat-bondable surface. At this moment, optimum temperature and time are appropriately selected as the temperature of the heating unit and the time for subjecting the film to contact-heating, in accordance with the materials and thicknesses of the films and zipper tapes to be used and the constitutions of the films to be laminated. The predetermined temperature means a temperature at which the heat-bondable surface and the tape base can be melted without melting or softening the outer surface of the bag. The predetermined period of time means a time period during which the heat-bondable surface and the tape base can be heated until the temperatures thereof reach their melting temperatures and during which the film on the outside of the bag is not melted, softened, or modified.

When subjecting the male zipper tape and the female zipper tape to a heat-bonding treatment simultaneously by a single guide unit, a groove (referred to as “second groove”) for guiding the engaging element of the zipper tape may be provided at a surface (referred to as “second flat surface”) that is on the other side of the guide unit and parallel to the first flat surface, and a heating unit (referred to as “second heating unit”) may be disposed in a position facing the second flat surface of the guide unit so that the same treatment can be conducted.

FIG. 5 is a diagram showing an entire schematic configuration of the heat bonding method according to the present invention.

FIG. 5 shows an example in which films are adhered to the female zipper tape and the male zipper tape, respectively, by using the guide unit provided with the first and second grooves.

As shown in FIG. 5, zipper tape reels for sending out the zipper tapes are disposed on the right-hand side. The female zipper tape and the male zipper tape are wound around these two zipper tape reels separately. These zipper tape reels are installed such that the surfaces of the tape-shaped bases are directed in the direction in which the first and second grooves of the guide unit are opened and such that the engaging elements pass through these grooves.

The film configuring the bag main body is obtained by stacking a film made of heat-bondable synthetic resin, on at least one of the surface layers thereof. Such a film is wound around each zipper tape reel, with the heat-bondable surface on the inside, to obtain a material web.

When allowing the material webs to pass through the heat bonding device, the material webs are installed such that the heat-bondable surfaces can come into contact with the first flat surface and the second flat surface of the guide unit.

Each of the zipper tapes and each of the films are sent to a guide roller 17. At this guide roller 17, each film 16 is superimposed on the tape-shaped base 2 constituting a base part of each zipper tape 1 (1a, 1b), and the superimposed film 16 and the zipper tape 1 are sent to a heat bonding part H.

A cooling unit (not shown), which has substantially the same shape as the heating unit and is kept cold at a certain temperature, is provided behind the first heating unit and the second heating unit installed in the heat bonding part H, and the guide unit extends to a lower part of the cooling unit.

After the films 16 and the tape-shaped bases 2 of the zipper tapes 1 are heat-fused at the heat bonding part H, the part that is melted by the heating unit is cooled and solidified by the cooling unit and sent to a zipper tape engaging roller 18 to engage the male engaging element 3b and the female engaging element 3a with each other. In this state, the resultant films are sent to the subsequent bag production step.

Heat-sealing for heat-fusing the films to each other in a normal bag production step is carried out through intermittent motion where the films are conveyed and stopped repeatedly. In other words, because the operations of the heat bonding part H also are carried out through the intermittent motion, the heat bonding device of the present invention can easily be incorporated not only just before the bag production step but also during the bag production step.

Embodiments of the present invention are described hereinafter in detail.

### Embodiment 1

The present embodiment describes how the zipper tape shown in FIG. 1 is heat-bonded to the film.

FIG. 6 is a diagram showing the details of the heat bonding part H of the heat bonding device shown in FIG. 5, FIG. 6 showing an end view of a surface that is perpendicular to a direction in which the zipper tape shown in FIG. 1 and the film flow and also an end view of a state in which the heating units are separated.

FIG. 7 is an end view showing a state in which the heating units shown in FIG. 6 are in pressure-contact with the guide unit.

A plate-shaped rectangular guide unit made of aluminum or other metal is used as a guide unit as shown in FIG. 3.

A first flat surface 5 of this plate-shaped guide unit 4 is provided with a first groove 7 that extends linearly in a longitudinal direction of the guide unit 4. This first groove 7 is slightly wider than the width of the female engaging element 3a, as deep as the height of the element part of the female engaging element 3a, and slightly shallower than the overall height of the zipper tape by the thickness of the tape-shaped base. A second flat surface 6 parallel to the first flat surface 5 is provided with a second groove 8 parallel to the first groove 7 at a predetermined position where the central positions of the grooves are aligned in a cross-sectional vertical direction. This second groove 8 is slightly wider than the width of the male engaging element 3b of the zipper tape, as deep as the height of the element part of the male engaging element 3b, and slightly shallower than the overall height of the zipper tape by the thickness of the tape-shaped base. With such a configuration, the engaging elements of the zipper tapes can be disposed within the first and second grooves, keeping the zipper tape straight without twisting the zipper tape.

Moreover, the guide unit 4 is provided with a cooling medium flow path as the cooling means for letting water or other cooling medium flow. A cooling medium of a certain temperature flows through the cooling medium flow path. Because the entire guide unit is kept at a certain temperature, the vicinities of the first and second grooves 7 and 8 can be kept at a certain temperature.

The thickness of the guide unit 4 can be set at an appropriate value according to the zipper tape and film to be used. Although not particularly limited, a favorable result can be obtained as long as the thickness of the guide unit is approximately 2.5 to 5 times the height of the zipper tape. In other words, when the thickness of the guide unit is 2.5 to 5 times the height of the zipper tape, the engaging elements can easily be engaged with each other by simply pressing the zipper tapes vertically from the film surfaces when the films are conveyed to the outside of the guide unit.

The first heating unit 10 shown in FIG. 4(a) is configured by a base part and a protruding strip part 14. A top surface (referred to as “third flat surface” hereinafter) of the protruding strip part 14 is a rectangular flat surface that faces the first flat surface 5 of the guide unit and is of the same length as the first groove 7 of the guide unit 4 and slightly wider than the width of the first groove 7.

The second heating unit 11 shown in FIG. 4(b) basically has the same shape as the first heating unit 10, wherein a top surface (referred to as “fourth flat surface” hereinafter) of the protruding strip part 14 is a rectangular flat surface that faces the second flat surface 6 of the guide unit and is of the same length as the second groove 8 of the guide unit 4 and slightly wider than the width of the second groove 8.

The heat bonding part is installed such that the first flat surface 5 of the guide unit faces upward while the second flat surface 6 faces downward and such that the directions in which the first and second grooves 7 and 8 of these flat surfaces extend become parallel to a direction in which the films 16 and the zipper tapes 1 are conveyed. The first heating unit 10 is installed so as to be parallel to the first groove 7 and such that the third flat surface 12 of the first heating unit 10 covers the first groove 7. Similarly, the second heating unit 11 is installed so as to be parallel to the second groove 8 and such that the fourth flat surface 13 of the second heating unit 11 covers the second groove 8. The first heating unit 10 and the second heating unit 11 are provided so as to be able to move vertically, i.e. in the directions of the arrows shown in the diagram. The first heating unit 10 and the second heating unit 11 are pressed to the guide unit 4 simultaneously or separated from the guide unit 4 simultaneously.

The female zipper tape is disposed at the first groove 7 of the guide unit 4 such that the tape-shaped base 2a of the female zipper tape is directed in the direction in which the first groove 7 is opened, and then the film is disposed so as to cover the female zipper tape. As with the case of the first groove, the male zipper tape and the film 16 are disposed at the second groove. When the heating unit 10 is separated, the film 16 and the first flat surface 5 of the guide unit 4 are separated from each other by the thickness of the tape base 2a because the depth of the first groove 7 is equal to the height of the female engaging element 3a. The third flat surface 12 of the first heating unit 10 is brought close to the position of the first flat surface 5 of the guide unit 4 in order to heat-bond the film 16 and the zipper tape with each other. As a result, the film 16 and the surface of the tape-shaped base 2a come into pressure-contact with each other.

At this moment, the engaging element 3a becomes compressed and slightly deformed in the first groove 7. When the temperature inside the groove is high, the engaging element 3a becomes softened and therefore thermally deformed by the heat. However, because the vicinity of the first groove 7 is kept cold by the cooling medium, thermal deformation of the engaging element 3a can be prevented, allowing the engaging element 3a to keep its elasticity, which is the characteristics of synthetic resin. In addition, the pressure of the contact between the film 16 and the tape-shaped base 2a can be kept in a favorable state by the elasticity of the engaging element 3a.

As described above, although the depths of the first and second grooves 7 and 8 are determined based on the materials of the female zipper tape 1a and the male zipper tape 1b, depths of the grooves need to be set to be slightly shallower than the heights of the respective zipper tapes and need to be set within a range that allows the shapes to be restored by the elasticity of the synthetic resin, because pressure needs to be applied to the zipper tapes.

Because the third flat surface 12 is wider than the width of the first groove 7, bringing the third flat surface 12 of the first heating unit 10 close to the position of the first flat surface 5 of the guide unit 4 eventually brings the first flat surface 5 of the guide unit 4 and the heat-bondable surface of the film 16 into pressure-contact with each other. At this moment, the first heating unit 10 may transmit, to the film 16, heat enough to melt the heat-bondable surface and bring the film into a heat-bondable state. However, the heat that is transmitted to the heat-bondable surface is released immediately to the guide unit 4, because the heat-bondable surface and the first flat surface 5 are in pressure-contact with each other. For this reason, the surface temperature of the heat-bondable surface does not increase to its melting temperature.

Thus, the heat-bondable surface of the film 16 does not stick to the first flat surface 5 of the guide unit 4, preventing the generation of wrinkles on the film 16, even when the film 16 and the zipper tapes are conveyed together.

As with the case of the first groove 7, the male zipper tape and the film 16 are disposed at the second groove 8. When the second heating unit 11 is separated, the film 16 and the third flat surface 6 of the guide unit 4 are separated from each other by the thickness of the tape base 2b because the depth of the second groove 8 is equal to the height of the male engaging element 3b. The fourth flat surface 13 of the second heating unit 11 is brought close to the position of the second flat surface 6 of the guide unit 4 in order to heat-bond the film 16 and the zipper tape with each other. As a result, the film 16 and the surface of the tape-shaped base 2b come into pressure-contact with each other. At the same time, the surface of the tape-shaped base 2b and the second flat surface 6 of the guide unit 4, too, are brought into pressure-contact with each other. At this moment, the second heating unit 11 may transmit, to the film 16, heat enough to bring a heat-bondable surface into a melted state.

When excessive heat is transmitted to the film 16, in some cases melting heat is also transmitted to the surface of the tape-shaped base 2b that comes into contact with the second flat surface 6 of the guide unit 4. In these cases, the melted tape-shaped base 2b may stick to the second flat surface 6.

However, because the vicinity of the second groove 8 of the guide unit is kept cold, the heat that is transmitted to the tape-shaped base 2b is released immediately to the guide unit 4, preventing the surface of the tape-shaped base 2b that comes into contact with the second flat surface 6 of the guide unit 4 from bringing to its melting temperature. Therefore, the tape-shaped base 2b does not stick to the second flat surface 6. Furthermore, the heat-bondable surface of the film 16 also does not stick to the second flat surface of the guide unit, preventing the generation of wrinkles on the film 16, even when the film 16 and the zipper tapes are conveyed together.

In addition, because the thickness of the guide unit 4 is set to be approximately 2.5 to 5 times the heights of the zipper tapes, the female zipper tape la and the male zipper tape lb are close to each other. As a result, the zipper tapes can be conveyed to the outside of the first and second grooves 7 and 8 and engaged immediately with each other. Moreover, because the zipper tapes are conveyed in the grooves without being twisted, the zipper tapes can be easily engaged with each other without being displaced.

As described above, the widths of the first and second grooves 7 and 8 are set based on the width of the engaging elements of the zipper tapes. However, the widths of the grooves need to be slightly wider than engaging elements in order to allow the passage of the engaging elements in the grooves, and need to be set within a range so as not to impede engagement of the engaging elements due to twisting of the tapes.

After the zipper tapes are heat-bonded to the films by the heat bonding device, the male zipper tape is engaged with the female zipper tape by the zipper tape engaging roller 18. The films with zipper tapes to which the zipper tapes are heat-bonded are passed on to the bag production step directly, with the male zipper tape and the female zipper tape engaged with each other.

In the bag production step, sides, bottom and other parts of a bag are heat-bonded at the necessary sections thereof and cut so as to be formed into a packaging bag. In so doing, members required for producing a general packaging bag with zippers are attached appropriately.

Examples of the general packaging bags with zippers include packaging bags such as a three side seal bag, four side seal bag, doypack, gusset bag, etc. that can be obtained by heat-bonding synthetic resin films.

In addition, the present embodiment is a method comprising producing a film with a zipper, heat-bonding necessary sections thereof to form a bag, and then cutting the bag. However, after producing the film with a zipper, the produced film may be cut into a predetermined shape and size, and thereafter necessary sections may be heat-bonded to each other to obtain a packaging bag.

Moreover, the bag produced from the film with a zipper can be filled with contents to obtain packaged body. The packaged body can be obtained by filling it with contents by means of an automatic filling and packaging machine using the film with a zipper.

Embodiment 1 above has described an example in which the grooves (the first and second grooves) are formed on respective surfaces (the first and second flat surfaces) of the guide unit and the male zipper tape and the female zipper tape are heat-bonded to the film simultaneously; however, another embodiment of the present invention may be practiced in which only one of the surfaces of the guide unit is provided with a groove to heat-bond the male or female zipper tape to the film.

### Embodiment 2

FIG. 2 is a diagram showing an example of the zipper tape used in the present embodiment.

In this zipper tape, a plurality of unit engaging elements are provided discontinuously in the longitudinal direction of the tape-shaped base and the discontinuously formed engaging elements are arranged in a plurality of parallel rows. This zipper tape can be engaged with another zipper tape by engaging a liner of engaging elements between opposing engaging elements, as viewed cross-sectionally in a width direction of the zipper tapes. In other words, rows of engaging elements of one zipper tape are shifted in the width direction so as to be positioned between rows of engaging elements of another zipper tape, and these engaging elements of the both zipper tapes are pressed against each other to push the engaging elements of the former zipper tape into the engaging elements of the latter zipper tape.

FIG. 8 shows an example in which the present embodiment is applied to the heat bonding part of the heat bonding device shown in FIG. 2, FIG. 8 showing an end view of a surface that is perpendicular to the direction in which the zipper tape and the film flow and an end view of a state in which the heating units are separated.

The first groove and the second groove of the guide unit are shifted to predetermined positions in the width direction so that the engaging elements on one side are positioned between the engaging elements on the other side.

The predetermined positions here indicate positions where the engaging elements on both zipper tapes are engaged with each other when both zipper tapes are pressed vertically against the film surface, without the guide unit therebetween.

When heat-bonding the zipper tapes to the film, in some cases approximately half of each tape-shaped base in the width direction is often heat-bonded to the film in order to provide a difference between the strength required for opening from the outside and the strength required for opening from the inside of the bag (see Japanese Patent Application Publication No. 2006-213366).

When heat-bonding only approximately half of each tape-shaped base as described above, the first heating unit and the second heating unit have the third flat surface and the fourth flat surface, respectively, which are configured to substantially cover predetermined parts in the width direction that correspond to approximately halves of the first groove and the second groove as shown in FIG. 8. Therefore, approximately half of each tape-shaped base in the width direction can be heat-bonded to the film. The rest of the configuration is same as that of Embodiment 1.

Furthermore, as with Embodiment 1, a packaging bag or packaged body can be produced by using the film with zippers.

The zipper tapes to be used are not limited to the ones described in Embodiments 1 and 2; thus, for example, one of the zipper tapes may have the engaging elements provided discontinuously in the longitudinal direction of the tape, and the other zipper tape may have the engaging element provided continuously in the longitudinal direction of the tape, as shown in FIG. 9. Alternatively, the plurality of rows of engaging elements may be formed on one of the zipper tapes.

Embodiment 2 above has described an example in which the grooves (the first and second grooves) are formed at either surface of the guide unit (the first and second flat surfaces) and the male zipper tape and the female zipper tape are heat-bonded to the film simultaneously; however, another embodiment of the present invention may be configured in which only one of the surfaces of the guide unit is provided with a groove to heat-bond the male or female zipper tape to the film.

### Example 1

An example of Embodiment 2 is described next. In the zipper tape shown in FIG. 2, the width of four rows of engaging elements was set at 5.2 mm, the height of the zipper tape at 1.2 mm, and the thickness and width of the tape-shaped base at 0.1 mm and 5.5 mm respectively. The material of the zipper tape was polypropylene.

The thickness of the guide unit was 5 mm. The width and depth of each of the first and second grooves were 5.4 mm and 1.2 mm, respectively. Water that was kept at 15° C. was used as the cooling medium.

The film was obtained by laminating together a biaxially-oriented polyethylene terephthalate film having a thickness of 12 mm and a cast polypropylene film having a thickness of 60 μm. The heat-bondable surface is a cast polypropylene film having a thickness of 60 μm.

The first and second heating units were kept at 160° C., and the widths of the third and fourth flat surfaces were set at 6 mm so as to cover approximately half of each of the first and second grooves.

When cooling water was not introduced to the guide unit, the heat-bondable surfaces of the films were adhered to the first and second flat surfaces of the guide unit, whereby wrinkles were formed on the films. When the cooling water was introduced to the guide unit, the films and the zipper tapes were heat-bonded to each other easily and successfully, without having the heat-bondable surfaces of the films adhered to the first and second flat surfaces of the guide unit.

### INDUSTRIAL APPLICABILITY

The heat bonding method according to the present invention is capable of heat-bonding together a zipper tape and a film without generating wrinkles on the film, even when heat-bonding the entire zipper tape including a tip end part of its flange to the film or even when the zipper tape does not have a flange. Therefore, the heat bonding method of the present invention is suitable for producing a film with a zipper for a packaging bag.

(FIG. 1-FIG. 9)
1 zipper tape
1a female zipper tape
1b male zipper tape
2 tape-shaped base
2a tape-shaped base (for a female engaging element)
2b tape-shaped base (for a male engaging element)
3 engaging element
3a female engaging element
3b male engaging element
4 guide unit
5 first flat surface
6 second flat surface
7 first groove
8 second groove
9 cooling medium flow path
10 first heating unit
11 second heating unit
12 third flat surface
13 forth flat surface
14 protruding strip part
15 zipper tape reel
1a female zipper tape
1b male zipper tape
16 film
17 guide roller
18 zipper tape engaging roller
19 film material roller

(FIG. 10 and FIG. 11)
3 main body film
4 flange part
5 seal receiver
6 heating unit

(FIG. 12)
1, 2 engaging element
3, 4 zipper tape
5, 6 main body film
15 overlaying roller
31 fusing means
32 rotating drum
33 zipper introducing groove
34 fusing surface
35 seal bar
36 looped belt
37 roller
38 press roller

1. A method for heat-bonding together a film and a zipper tape having one or more engaging elements on one surface side of a tape-shaped base, the heat bonding method comprising the steps of: using a heat bonding device including a guide unit which has at one surface thereof (a first flat surface) a linearly extending groove (a first groove) for guiding the engaging elements of the zipper tape, the groove being slightly wider than a width of the engaging elements and slightly shallower than a height of the zipper tape, and which has cooling means for keeping a vicinity of the first groove cold, and a first heating unit that is disposed facing the first flat surface of the guide unit, has a surface (a third flat surface) that is so shaped as to substantially cover a predetermined part of the first groove, and has a mechanism such that the third flat surface approaches and is separated from the position of the first flat surface, transferring the zipper tape when the third flat surface of the first heating unit is separated from the position of the first flat surface of the guide unit, to allow the passage of the engaging elements in the first groove so that the zipper tape is disposed such that the tape-shaped base is directed in a direction in which the first groove is opened; disposing the film so as to cover the zipper tape; and heat-bonding together the zipper tape and the film by bringing the third flat surface of the first heating unit close to the position of the first flat surface to subject the film to contact-heating for a predetermined period of time, the first heating unit being kept at a predetermined temperature.

2. A method for heat-bonding together films and zipper tapes each having one or more engaging elements on one surface side of a tape-shaped base, the heat bonding method comprising the steps of: using a heat bonding device including a guide unit which has at a surface (a first flat surface) on one side thereof a linearly extending groove (a first groove) for guiding the engaging elements of one of the zipper tapes, the groove being slightly wider than a width of the engaging elements and slightly shallower than a height of the zipper tape, which has, at a position corresponding to the first groove and at a surface (a second flat surface) on the other side thereof parallel to the first flat surface, a linearly extending groove (a second groove) for guiding the engaging elements of the other zipper tape, the groove being slightly wider than the width of the engaging elements, slightly shallower than the height of the zipper tape and parallel to the first groove, and which has cooling means for keeping vicinities of the first and second grooves cold, a first heating unit that is disposed facing the first flat surface of the guide unit, has a surface (a third flat surface) that is so shaped as to substantially cover a predetermined part of the first groove, and has a mechanism such that the third flat surface approaches and is separated from the position of the first flat surface, and a second heating unit that is disposed facing the second flat surface of the guide unit, has a surface (a fourth flat surface) that is so shaped as to substantially cover a predetermined part of the second groove, and has a mechanism such that the fourth flat surface approaches and is separated from the position of the second flat surface, transferring the zipper tapes when the third flat surface of the first heating unit is separated from the position of the first flat surface of the guide unit and the fourth flat surface of the second heating unit is separated from the position of the second flat surface of the guide unit, to allow the passage of the engaging elements in the first and second grooves so that the zipper tapes are respectively disposed such that the tape-shaped bases are directed in a direction in which the first and second grooves are opened; disposing the films so as to cover the zipper tapes; and heat-bonding together the zipper tapes and the films by bringing the third flat surface of the first heating unit close to the position of the first flat surface of the guide unit and bringing the fourth flat surface of the second heating unit close to the position of the second flat surface of the guide unit, to subject the films to contact-heating for a predetermined period of time, the first heating unit being kept at a predetermined temperature.

3. The heat bonding method according to claim 1, wherein, in the zipper tape, the engaging elements are provided as a continuous row in a longitudinal direction of the zipper tape.

4. The heat bonding method according to claim 1, wherein, in the zipper tape, the engaging elements are provided discontinuously in a longitudinal direction of the zipper tape, and a plurality of rows of the discontinuous engaging elements are provided in a width direction of the zipper tape.

5. The heat bonding method according to claim 2, wherein the zipper tapes are configured such that the engaging elements of one of the zipper tapes are provided discontinuously in a longitudinal direction of the tape and a plurality of rows of the discontinuous engaging elements are provided in a width direction, while the engaging elements of the other zipper tape are provided as a continuous row in a longitudinal direction of the tape.

6. A heat bonding device for heat-bonding together a film and a zipper tape having one or more engaging elements on one surface side of a tape-shaped base, the heat bonding device comprising: a guide unit which has at one surface thereof (a first flat surface) a linearly extending groove (a first groove) for guiding the engaging elements of the zipper tape, the groove being slightly wider than a width of the engaging elements and slightly shallower than a height of the zipper tape, and which has cooling means for keeping a vicinity of the first groove cold; and a first heating unit that is disposed facing the first flat surface of the guide unit, has a surface (a third flat surface) that is so shaped as to substantially cover a predetermined part of the first groove, and has a mechanism such that the third flat surface approaches and is separated from the position of the first flat surface.

7. A heat bonding device for heat-bonding together films and zipper tapes each having one or more engaging elements on one surface side of a tape-shaped base, the heat bonding device comprising: a guide unit which has at one of surfaces thereof (a first flat surface) a linearly extending groove (a first groove) for guiding the engaging elements of one of the zipper tapes, the groove being slightly wider than a width of the engaging elements and slightly shallower than a height of the zipper tape, which has, at a predetermined position of a surface (a second flat surface) on the other side thereof parallel to the first flat surface, a linearly extending groove (a second groove) for guiding the engaging elements of the other zipper tape, the groove being slightly wider than the width of the engaging elements, slightly shallower than the height of the other zipper tape and parallel to the first groove, and which has cooling means for keeping vicinities of the first and second grooves cold; a heating unit that is disposed facing the first flat surface of the guide unit, has a surface (a third flat surface) that is so shaped as to substantially cover a predetermined part of the first groove, and has a mechanism such that the third flat surface approaches and is separated from the position of the first flat surface; and another heating unit that is disposed facing the second flat surface of the guide unit, has a surface (a fourth flat surface) that is so shaped as to substantially cover a predetermined part of the second groove, and has a mechanism such that the fourth flat surface approaches and is separated from the position of the second flat surface.

8. The heat bonding device according to claim 6, wherein the cooling means is provided in the vicinity of the first groove of the guide unit and is a flow path capable of allowing the passage of a cooling medium therethrough.

9. A film with a zipper tape, which is produced by the heat bonding method described in claim 1.

10. A packaging bag, which is produced using the film with a zipper tape described in claim 9.

11. A packaged body, which is obtained by filling up the packaging bag described in claim 10 with contents.

12. The heat bonding method according to claim 2, wherein, in the zipper tapes, the engaging elements are provided as a continuous row in a longitudinal direction of each of the zipper tapes.

13. The heat bonding method according to claim 2, wherein, in the zipper tapes, the engaging elements are provided discontinuously in a longitudinal direction of the zipper tape or tapes, and a plurality of rows of the discontinuous engaging elements are provided in a width direction of each of the zipper tapes.

14. The heat bonding device according to claim 7, wherein the cooling means is provided in the vicinity of the first groove of the guide unit and is a flow path capable of allowing the passage of a cooling medium therethrough.

15. A film with a zipper tape, which is produced by the heat bonding method described in claim 2.

16. A packaging bag, which is produced using the film with a zipper tape described in claim 15.

17. A packaged product, which is obtained by filling up the packaging bag described in claim 16 with contents.
